(19) United States
(12) Patent Application Publication
(10) Pub. No.: US 2017/0037904 A1
(43) Pub. Date: Feb. 9, 2017

(54) RADIAL NEEDLE BEARING WITH FLANGE CUTOUTS

(71) Applicant: Schaeffler Technologies AG & Co. KG, Herzogenaurach (DE)

(72) Inventors: Alaa Makke, Farmington Hills, MI (US); Victoria Poole, Livonia, MI (US)

(73) Assignee: Schaeffler Technologies AG & Co. KG, Herzogenaurach (DE)

(21) Appl. No.: 14/818,668

(22) Filed: Aug. 5, 2015

(51) Int. Cl. F16C 33/66; F16C 19/46

(52) U.S. Cl. CPC F16C 33/6681; F16C 19/463

(57) ABSTRACT

The disclosure describes an outer raceway for a rolling element bearing that contains lubrication cutouts in at least one of the side walls. These lubrication cutouts provide for an increased amount of oil or lubrication to access the critical rolling element interfaces.

### TECHNICAL FIELD

Example aspects described herein relate to bearing assemblies, particularly of bearing assemblies that contain rolling elements together with a drawn or formed steel outer ring or shell that has inwardly extending radial flanges at each of its ends.

### BACKGROUND

Bearing assemblies are typically circular in shape, and generally comprised of rolling elements, normally contained by a cage, disposed between inner and outer raceways. Rolling elements take many forms, including spherical balls, cylindrical rollers, needle rollers, or various other configurations, such as cone-shaped tapered rollers or barrel-shaped spherical rollers. Cages are often used to contain the rolling elements and guide them throughout the rotating motion of the bearing, but are not a necessity in some configurations. The material of a cage can vary from steel to plastic, depending on the application, duty cycle, along with noise and weight requirements. Outer raceways are contained within drawn or machined steel rings. Drawn steel outer rings, or shells, as they are sometimes called, can be fabricated by a process in which a sheet metal blank undergoes plastic deformation by a series of punch and die steps to achieve the final desired shape. Within this forming process a flange can be formed on one end of the drawn outer ring to facilitate axial containment in a single direction after the cage and rolling elements are assembled within the outer ring. After assembly, a second flange can be formed on the opposite end, facilitating axial cage containment in both directions. The inside and outside surfaces of the drawn ring are very smooth; consequently, the inside surface can serve as a contact partner or outer raceway for the rolling elements, and its outer surface is an ideal press-in interface with an enclosure or housing. Relative to a machined steel ring, the walls of a drawn steel ring are thinner, requiring less packaging space; in addition, the manufacturing cost of a drawn steel ring is less than that of a machined steel ring.

One of the fundamental needs of a bearing to achieve its targeted life is lubrication. The primary lubricants utilized for bearings are grease and oil and depend on the application, duty cycle and life requirements. Oil lubrication of a rolling element bearing can be accomplished via a direct feed or by splash or mist oil and does not have to be transported in its pure form. In two-stroke engines, bearing components are lubricated from the oil that is mixed with the gasoline and circulated in the engine before combustion. In automotive air conditioner compressors, the lubrication is carried to the bearing components by means of the refrigerant that contains oil.

In addition to the presence of oil, the layout and packaging of the bearing and shaft system should be such that the oil can penetrate the rolling element assembly, working its way around and between the rolling elements. This facilitates an oil film between the rolling elements and respective raceways in addition to keeping the bearing assembly cool. To enable adequate lubrication to reach these critical interfaces, a clear path for the oil to reach the rolling elements of the bearing should be ensured. This pathway can be blocked with either adjacent components near the bearing and shaft assembly or by the physical features of the bearing.

### SUMMARY OF THE INVENTION

A new design for a drawn outer ring of a rolling element bearing is disclosed. In one example embodiment, the flanges of the outer ring contain cutouts to allow more lubricant to reach the rolling element assembly of the bearing, thus, extending its lifetime.

### BRIEF DESCRIPTION OF DRAWINGS

The above mentioned and other features and advantages of the embodiments described herein, and the manner of attaining them, will become apparent and be better understood by reference to the following description of at least one example embodiment in conjunction with the accompanying drawings. A brief description of the drawings now follows.

FIG. 1 is a perspective view of one example embodiment of a rolling element bearing assembly with a drawn outer ring that contains flange cutouts.

FIG. 2 is a perspective view of one example embodiment of the drawn outer ring of FIG. 1.

FIG. 3 is a perspective view of the bearing assembly of FIG. 1 together with a shaft.

FIG. 4a is a sectional and perspective view of the initial blanking step to produce a drawn outer ring.

FIG. 4b is a sectional and perspective view of a subsequent drawing step following the blanking step in FIG. 4a when producing a drawn outer ring.

FIG. 4c is a sectional and perspective view of yet another subsequent drawing step following the first drawing step in FIG. 4c.

FIG. 4d is a sectional and perspective view of a piercing step that follows the multiple drawing steps when producing a drawn outer ring.

FIG. 5 is a perspective view of a prior art rolling element bearing assembly.

FIG. 6 is a perspective assembly view of the prior art bearing assembly of FIG. 5 together with a shaft.

### DETAILED DESCRIPTION OF THE INVENTION

Identically labeled elements appearing in different figures refer to the same elements but may not be referenced in the description for all figures. The exemplification set out herein illustrates at least one embodiment, in at least one form, and such exemplification is not to be construed as limiting the scope of the claims in any manner. A radially inward direction is from an outer radial surface of the outer raceway, toward the central axis or radial center of the outer raceway. Conversely, a radial outward direction indicates the direction from the central axis or radial center of the outer raceway toward the outer surface. Axially refers to directions along a diametric central axis.

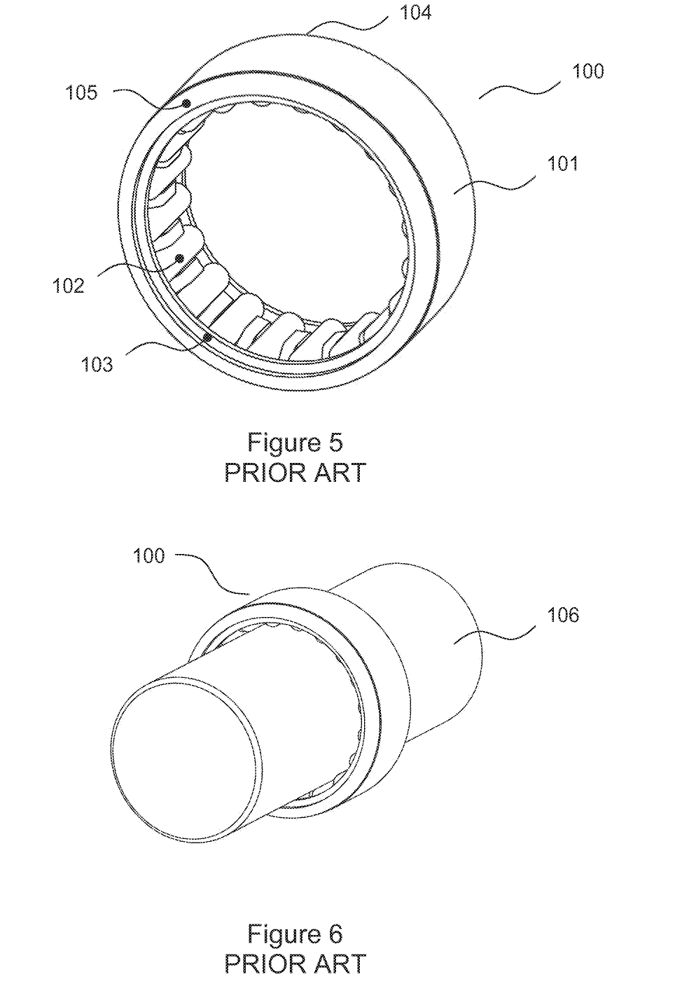

FIG. 5 is a perspective view of a prior art rolling element bearing assembly 100. The bearing assembly comprises outer ring 101, rolling elements 102, cage 103, and flanges 104 and 105.

FIG. 6 is a perspective view of prior art rolling element bearing assembly 100 installed on shaft 106. The flange of the outer ring provides a barrier for any oil or oil carrying medium to enter the bearing. In some applications where only small amounts of lubrication are available for the bearing, this barrier can significantly reduce the lifetime of the bearing.

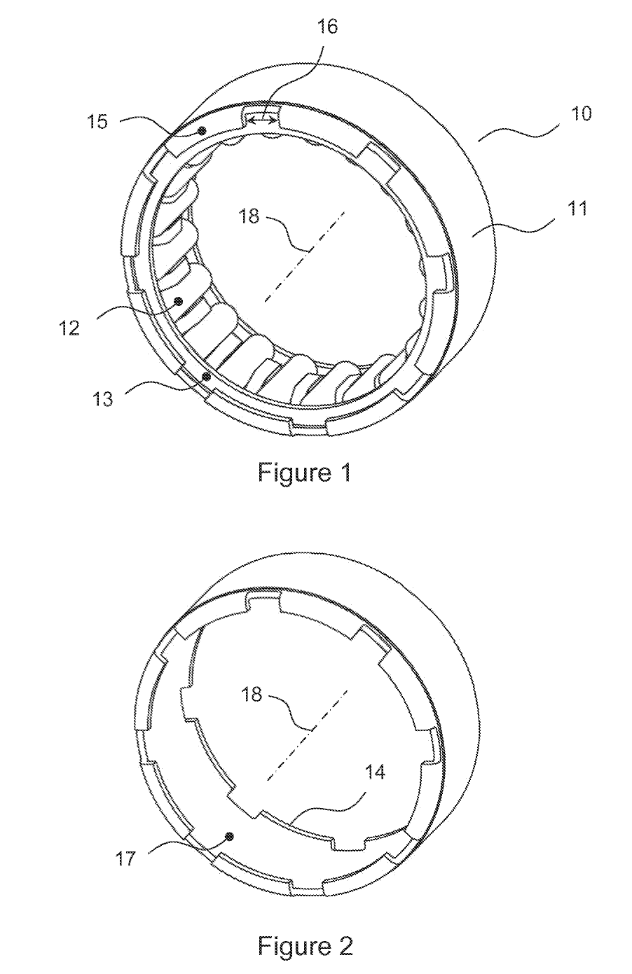

FIG. 1 is a perspective view of a rolling element bearing according to an example embodiment. FIG. 2 is a perspective view of the assembly of FIG. 1 with the cage and rolling elements removed. The following description should be viewed in light of FIG. 1 and FIG. 2. The bearing assembly 10 consists of an outer ring 11, rolling elements 12 and a cage 13. Outer ring 11 contains first flange 14, second flange 15 and outer raceway 17. Outer raceway 17 provides a direct interface for rolling elements 12. In one example embodiment, the outer ring can be fabricated via a drawing process from a piece of sheet metal that is on the order of 0.5 to 4 millimeters in thickness. Flange 14 can be a result of a piercing process while flange 15 can be formed by bending the edge of the drawn ring so that it extends radially inward toward central axis 18 after the cage assembly has been installed within the outer ring. It should be noted Flanges 14 and 15 contain the cage assembly in the axial direction, while permitting rotational motion of the cage assembly about central axis 18 relative to the outer ring. Cutouts 16 are located on flanges 14 and 15 to make it easier for oil to access the cage and rolling element assembly. In another embodiment (not shown) it is also possible for these lubrication cutouts to be present on one of the flanges rather than both. Given the 0.5 to 4 millimeter thickness of the outer raceway, a blanking, shearing, punching or similar process can be utilized to achieve the cutouts in either of flanges 14 or 15. In addition, a grinding process can also be applied to remove the required material.

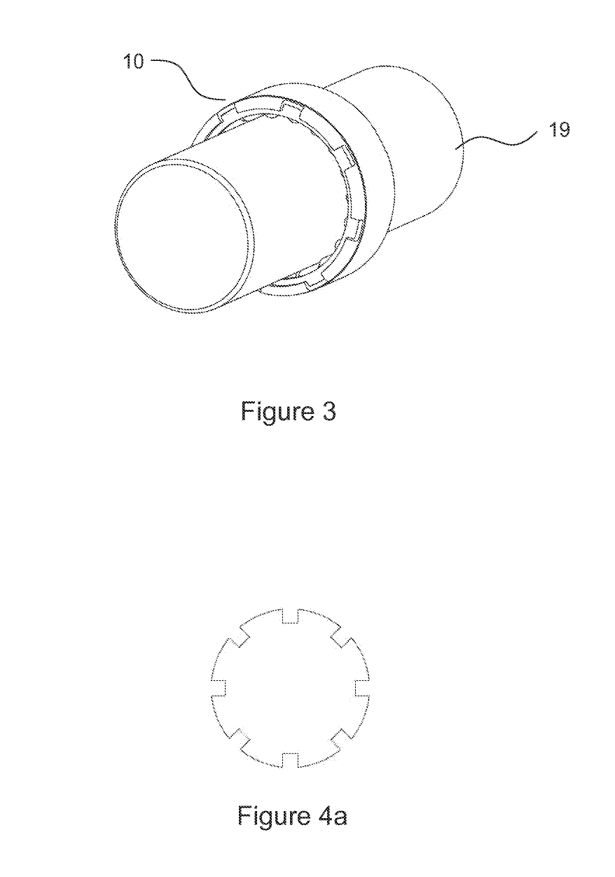

FIG. 3 is a perspective view of the rolling element bearing assembly of FIG. 1 installed on shaft 19. Shaft 19 serves as an inner raceway for the bearing assembly, such that it provides a direct interface for the rolling elements. From this view one can observe the increased lubrication access to the cage and roller assembly due to the presence of cutouts 16. Lubrication is able to migrate past the cage more easily to access the outer raceway interface with the rollers. The presence of cutouts on both sides of the bearing can potentially provide a means for flushing out unwanted debris that is present inside of the bearing. With increased lubrication and reduced particle contamination, the life of the bearing is extended.

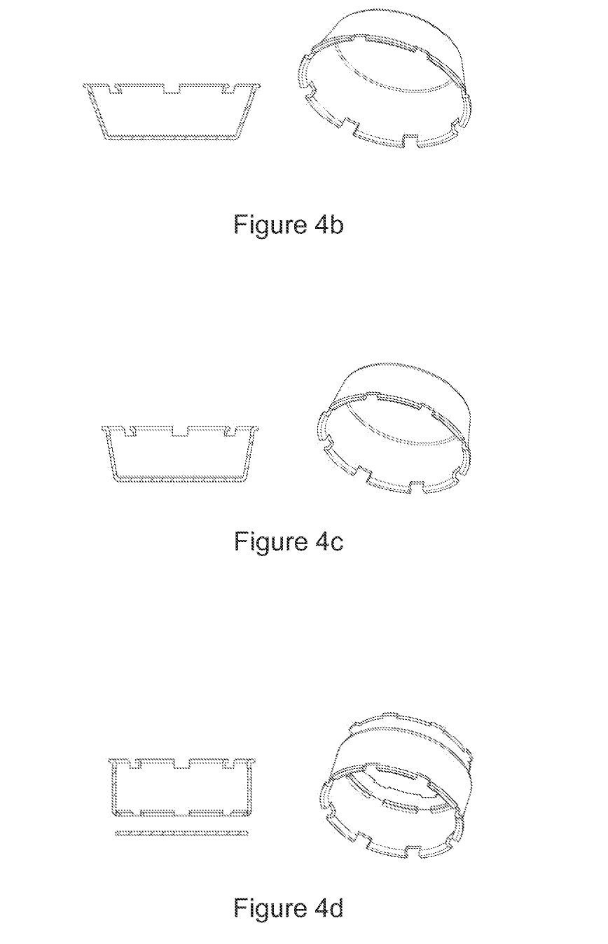

FIGS. 4a, 4b, 4c and 4d provide perspective views of one embodiment of the different stages of a drawing process that can be utilized to achieve the cutouts in flanges 14 and 15 that are depicted in FIG. 2. It should be noted that the resultant outer ring does not have flange 15 due to the fact that this flange is formed after the cage and rolling elements have been installed. The process starts with a blanking stage that results in a circular disk with cutouts. If cutouts are not applied during the initial blanking stage, they can be added to the circumference of the circular disk by shearing, punching, grinding or other similar material removal processes. Subsequent forming steps are followed by a piercing step that removes a large portion of the bottom surface of the formed cup, leaving flange 14 and its respective cutouts. If the cutouts are not applied during the piercing step, they can be added by shearing, punching, grinding or other similar material removal processes. Those skilled in the art of the drawing process would recognize that more forming steps may be required than what is shown in FIGS. 4a-4d. Additionally, the number of cutouts could be more or less than what is shown in FIGS. 4a-4d. In order to achieve cutouts on only one of the flanges, the initial blanking step could be accomplished without the cutouts, or the final piercing step could leave out the cutouts.

In the foregoing description, example embodiments are described. The specification and drawings are accordingly to be regarded in an illustrative rather than in a restrictive sense. It will, however, be evident that various modifications and changes may be made thereto, without departing from the broader spirit and scope of the present invention.

In addition, it should be understood that the figures illustrated in the attachments, which highlight the functionality and advantages of the example embodiments, are presented for example purposes only. The architecture or construction of example embodiments described herein is sufficiently flexible and configurable, such that it may be utilized (and navigated) in ways other than that shown in the accompanying figures.

Although example embodiments have been described herein, many additional modifications and variations would be apparent to those skilled in the art. It is therefore to be understood that this invention may be practiced otherwise than as specifically described. Thus, the present example embodiments should be considered in all respects as illustrative and not restrictive.

### LIST OF REFERENCE SYMBOLS

10 Bearing Assembly
11 Outer Ring
12 Rolling Element
13 Cage
14 First Flange
15 Second Flange
16 Cutout
17 Outer Raceway
18 Central Axis
19 Shaft
100 Bearing Assembly
101 Outer Ring
102 Rolling Element
103 Cage
104 First Flange
105 Second Flange
106 Shaft

What we claim is:

1. A bearing assembly comprising:
an outer ring; having:
an inner radial surface;
an outer radial surface;
a first flange at a first axial end extending radially inward;
a second flange at a second axial end extending radially inward; and
at least one cutout defined by at least one of the first and the second flanges; and
a cage; having:
a plurality of rolling elements disposed within the cage.

2. The bearing assembly of claim 1, wherein the first flange defines at least one cutout and second flange defines at least one cutout.

3. The bearing assembly of claim 1, wherein the at least one cutout defined by the first flange is a plurality of cutouts.

4. The bearing assembly of claim 1, wherein the at least one cutout defined by the second flange is a plurality of cutouts.

5. The bearing assembly of claim 1, wherein the outer ring material is steel.

6. A method of forming an outer ring for a bearing, comprising the steps of:
blanking a metal disk;
drawing the metal disk into a final cup shape in multiple steps; and
forming a first flange at the bottom of the cup with at least one cutout.

7. The method of claim 6 wherein the blanking step also produces at least one cutout on the circumference of the metal disk.

8. The method of claim 6 further comprising grinding at least one cutout on the circumference of the metal disk.

9. The method of claim 6 wherein the forming step is accomplished by piercing.

10. The method of claim 6 wherein the at least one cutout is formed by a grinding process.

11. The method of claim 6 wherein the at least one cutout is formed by a shearing process.

12. The method of claim 6 wherein the at least one cutout is formed by a punching process.

13. A method of forming an outer ring for a bearing, comprising the steps of:
forming a metal disk with at least one cutout on the circumference of the metal disk;
drawing the metal disk into a final cup shape in multiple steps; and
piercing a flange at the bottom of the cup.

14. The method of claim 13 wherein the forming step is accomplished by blanking

15. The method of claim 13 wherein the at least one cutout is formed by a blanking process.

16. The method of claim 13 wherein the at least one cutout is formed by a grinding process.

17. The method of claim 13 wherein the at least one cutout is formed by a shearing process.

18. The method of claim 13 wherein the at least one cutout is formed by a punching process.
